(19) United States
(12) Patent Application Publication
(10) Pub. No.: US 2008/0136800 A1
(43) Pub. Date: Jun. 12, 2008

(54) Plasma display apparatus

(76) Inventor: Jeongpil Choi, Seoul (KR)

Correspondence Address: BIRCH STEWART KOLASCH & BIRCH, PO BOX 747, FALLS CHURCH, VA, 22040-0747, US

(21) Appl. No.: 12/000,276

(22) Filed: Dec. 11, 2007

(30) Foreign Application Priority Data
Dec. 12, 2006 (KR) 10-2006-0126010
Apr. 30, 2007 (KR) 10-2007-0042132

(51) Int. Cl. G06F 3/038; G09G 3/28

(52) U.S. Cl. 345/204; 345/60

(57) ABSTRACT

A plasma display apparatus comprising the driving module supplying scan pulses to scan electrodes during an address period and supplying sustain pulses to scan/sustain electrodes during a sustain period, a first resonance forming unit that supplies energy for forming the sustain pulses to the scan/sustain electrodes, a second resonance forming unit that recovers energy for forming the sustain pulses from the scan/sustain electrodes, an energy storage unit that stores the energy during the sustain period and an energy controller that forms a path for supplying the energy to the scan/sustain electrodes or a path for recovering the energy from the scan/sustain electrodes, wherein the first resonance forming unit comprises a first inductor, wherein the second resonance forming unit comprises a second inductor and wherein inductance of the first inductor is different from inductance of the second inductor.

This application claims the benefit of Korean Patent Application Nos. 10-2006-0126010 and 10-2007-0042132 filed on Dec. 12, 2006 and Apr. 30, 2007, which is hereby incorporated by reference.

### BACKGROUND

1. Field

This document relates to a plasma display apparatus.

2. Related Art

In general, a plasma display apparatus comprises a plasma display panel (PDP) for displaying an image and a driver for driving the PDP. The PDP comprises a top surface substrate and a bottom surface substrate. Barrier ribs for partitioning off discharge cells are formed between the top surface substrate and the bottom surface substrate.

Inert gases injected into the discharge cells generate discharge by a radiofrequency voltage. Vacuum ultraviolet (UV) rays are generated by the discharge and the vacuum UV rays emit light from a phosphor formed between the barrier ribs to realize an image.

FIG. 1 illustrates the driver of a common plasma display apparatus.

In a reset period, a set up switch Q5 and a seventh switch Q7 are turned on and a sustain voltage Vs supplied from a sustainer 10 is supplied to scan electrodes Yn−1 and Yn via the body diode of a sixth switch Q6, a seventh switch Q7, and the 15^{th} switches Q15n−1 and Q15n of a drive integrated circuit 14n.

At this time, when the set up switch Q5 that operates in an active region is turned on, set up pulses that gradually rise from the sustain voltage Vs to the sum Vs+Vst of the sustain voltage Vs and a set up voltage Vst are supplied to the scan electrodes Yn−1 and Yn through the seventh switch Q7 and the 15^{th} switches Q15-1 and Q15n of the drive integrated circuit 14n.

When the set up switch Q5 is turned of after the set up pulses are supplied to the scan electrodes Yn−1 and Yn, only the sustain voltage Vs supplied from the sustainer 10 is supplied to the scan electrodes Yn−1 and Yn.

Then, the seventh switch Q7 is turned off and a set down switch Q10 that operates in the active region is turned on. Therefore, set down pulses that gradually fall from the sustain voltage Vs to a write scan voltage −Vyw are supplied to the scan electrodes Yn−1 and Yn.

In order to scan the (n−1)th scan electrode Yn−1 during an address period, an 11^{th} switch Q11 and the 15^{th} switch Q15n−1 of a drive integrated circuit 14n−1 are turned so that the write scan voltage −Vyw is supplied to the (n−1)th scan electrode Yn−1. At this time, an eighth switch Q8, a ninth switch Q9, and the 14^{th} switch Q14n of the drive integrated circuit 14n are turned on so that a scan bias voltage Vsc corresponding to the sum of the write scan voltage −Vyw and the scan voltage Vsc is supplied to the nth scan electrode Yn. When the (n−1)th scan electrode Yn−1 is scanned, the nth scan electrode Yn is scanned. Data pulses corresponding to image signals are supplied to the address electrodes (not shown) of the PDP in synchronization with a period in which the write scan voltage −Vyw is supplied. Therefore, discharge cells in which sustain discharge is to be generated during a sustain period are selected.

The sustain pulses generated by the sustainer 10 during the sustain period are supplied to the (n−1)th scan electrode Yn−1 and the nth scan electrode Yn through the 15^{th} switches Q15n−1 and Q15n of the drive integrated p circuits 14n−1 and 14n.

In the driver of a common plasma display apparatus, since the sustainer 10 and the drive integrated circuits 14n−1 and 14n are separated from each other, a circuit structure is complicated.

### SUMMARY

In one aspect, a plasma display apparatus, comprising, a plasma display panel (PDP) comprising scan electrodes and sustain electrodes, a driving integrated circuit comprising a driving module, the driving module supplying scan pulses to the scan electrodes during an address period and supplying sustain pulses to the scan electrodes and the sustain electrodes during a sustain period, a first resonance forming unit that supplies energy for forming the sustain pulses to the scan electrodes and the sustain electrodes, a second resonance forming unit that recovers energy for forming the sustain pulses from the scan electrodes and the sustain electrodes, an energy storage unit that stores the energy during the sustain period and an energy controller that forms a path for supplying the energy to the scan electrodes and the sustain electrodes or a path for recovering the energy from the scan electrodes and the sustain electrodes, wherein the first resonance forming unit comprises a first inductor, wherein the second resonance forming unit comprises a second inductor and wherein inductance of the first inductor is different from inductance of the second inductor.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 illustrates the driver of a common plasma display apparatus;

FIG. 2 illustrates a plasma display apparatus according to an embodiment of the present invention;

FIG. 3 illustrates the structure of a plasma display panel (PDP) according to an embodiment of the present invention;

FIG. 4 illustrates the operation of the plasma display apparatus according to an embodiment of the present invention;

FIG. 5 illustrates a plasma display apparatus comprising a driving integrated circuit according to an embodiment of the present invention;

FIG. 6 illustrates the switching timing of the plasma display apparatus comprising the driving integrated circuit according to an embodiment of the present invention;

FIGS. 7A to 7D illustrates a method of driving the driving integrated circuit in accordance with the switching timing of FIG. 6;

FIG. 8 illustrates a plasma display apparatus comprising a driving integrated circuit according to another embodiment of the present invention;

FIG. 9 illustrates a plasma display apparatus comprising a driving integrated circuit according to still another embodiment of the present invention;

FIG. 10 illustrates a plasma display apparatus comprising a driving integrated circuit according to still another embodiment of the present invention;

FIG. 11 illustrates that driving integrated circuits comprised in a scan driver and a sustain driver according to various embodiments of the present invention are provided on the bottom surface of a PDP; and

FIG. 12 illustrates that scan electrodes and sustain electrodes are independently controlled by the driving integrated circuits according to various embodiment of the present invention.

### DETAILED DESCRIPTION

Preferred embodiments of the present invention will be described in a more detailed manner with reference to the drawings.

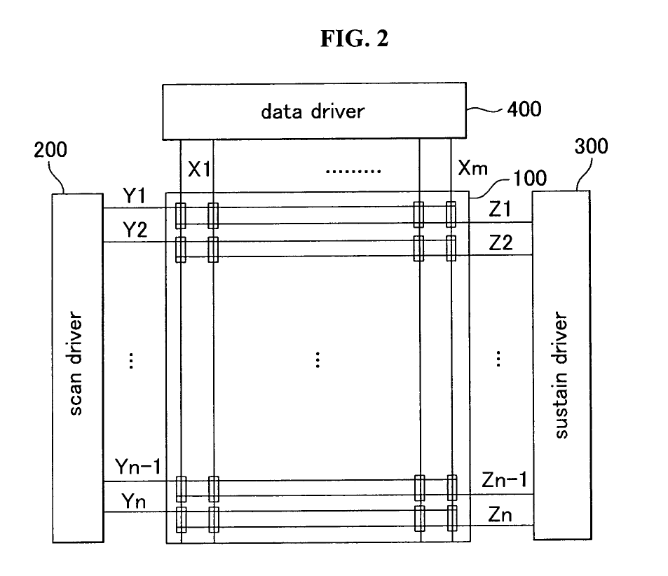

FIG. 2 illustrates a plasma display apparatus according to an embodiment of the present invention.

Referring to FIG. 2, the plasma display apparatus according to an embodiment of the present invention comprises a plasma display panel (PDP) 100 comprising electrodes, a scan driver 200, a sustain driver, and a data driver 400.

In the PDP 100, a top surface panel (not shown) and a bottom surface panel (not shown) are attached to each other by a predetermined distance. The PDP 100 comprises scan electrodes Y1 to Yn, sustain electrodes Z1 to Zn, and address electrodes X1 to Xm.

The scan driver 200, the sustain driver 300, and the data driver 400 supply predetermined driving pulses to the plurality of electrodes formed on the PDP 100 in at least one subfields comprised in one frame.

The scan driver 200 can supply reset pulses to the scan electrodes Y1 to Yn so that wall charges can be uniformed formed discharge cells. The scan driver 200 supplies scan pulses for selecting discharge cells in which discharge is to be generated during an address period and sustain pulses for generating sustain discharge in discharge cells selected during a sustain period to the scan electrodes Y1 to Yn.

In addition, the scan driver 200 supplies the scan pulses to the scan electrodes Y1 to Yn during the address period through a driving integrated circuit or supplies the sustain pulses and a sustain voltage Vs to the scan electrodes Y1 to Yn during the sustain period through the driving integrated circuit.

The sustain driver 300 supplies sustain bias pulses to the sustain electrodes Z1 to Zn in a period where falling ramp pulses Ramp-down are generated under the control of a timing controller (not shown) and during the address period and supplies the sustain pulses to the sustain electrodes Z1 to Zn during the sustain period so that an image is displayed.

In addition, the sustain driver 300 supplies the sustain pulses and the sustain voltage Vs to the sustain electrodes Z1 to Zn during the sustain period through the driving integrated circuit.

The data driver 400 supplies data reverse gamma corrected and error diffused by a reverse gamma correcting circuit (not shown) and an error diffusing circuit (not shown) and mapped to subfields by a subfield mapping circuit. The data driver 400 samples and latches data in response to data timing control waveforms from the timing controller (not shown) and supplies the latched data to the address electrodes X1 to Xm.

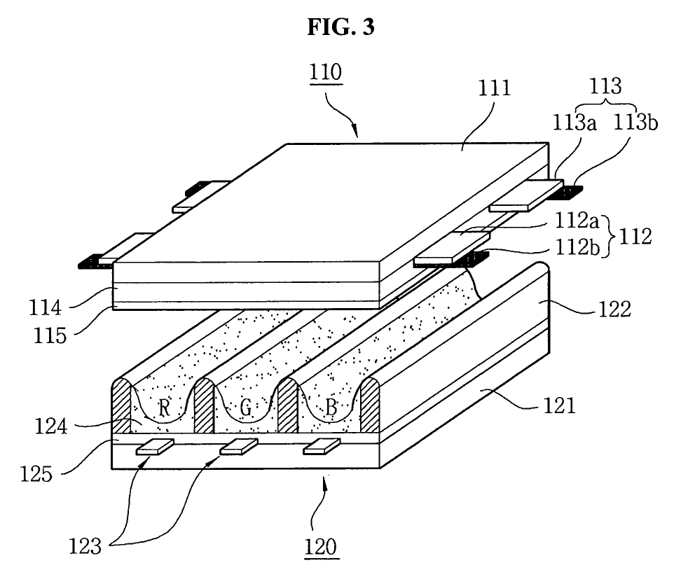

FIG. 3 illustrates the structure of a plasma display panel (PDP) according to an embodiment of the present invention.

Referring to FIG. 3, the PDP according to an embodiment of the present invention is formed by attaching a top surface panel 110 comprising a top surface substrate 111 on which a scan electrode 112 and a sustain electrode 113 are formed and a bottom surface panel 120 comprising a bottom surface substrate 121 on which address electrodes 123 that intersect the scan electrode 112 and the sustain electrode 113 are formed to each other by a predetermined distance.

Here, the scan electrode 112 and the sustain electrode 113 formed on the top surface substrate 111 are formed to run parallel with each other to generate discharge in discharge cells and to sustain the discharge of the discharge cells.

The scan electrode 112 and the sustain electrode 113 formed on the top surface substrate 111 emit light generated by the discharge cells to the outside in consideration of a transmittance and a conductivity in order to secure driving efficiency. Therefore, the scan electrode 112 and the sustain electrode 113 comprise bus electrodes 112b and 113b made of a metal such as Ag, respectively, and transparent electrodes 112a and 113a made of transparent indium tin oxide (ITO), respectively.

The scan electrode 112 and the sustain electrode 113 comprise the transparent electrodes 112a and 113a, respectively, in order to effectively emit visible rays generated by the discharge cells to the outside of the PDP.

In addition, the scan electrode 112 and the sustain electrode 113 comprise the bus electrodes 112b and 113b, respectively, in order to compensate for the low conductivity of the transparent electrodes 112a and 113a since, when the scan electrode 112 and the sustain electrode 113 comprise only the transparent electrodes 112a and 113a, respectively, the conductivity of the transparent electrodes 112a and 113a is low so that driving efficiency can be reduced

An upper dielectric layer 114 can be formed on the top surface substrate 111 where the scan electrode 112 and the sustain electrode 113 are formed to cover the scan electrode 112 and the sustain electrode 113.

The upper dielectric layer 114 limits the discharge current of the scan electrode 112 and the sustain electrode 113 and insulates the scan electrode 112 and the sustain electrode 113 from each other.

A protective layer 115 for facilitating discharge can be formed on the upper dielectric layer 114. The protective layer 115 can be formed of MgO having a high emission coefficient.

On the other hand, the address electrodes 123 formed on the bottom surface substrate 121 supply data pulses to the discharge cells.

A lower dielectric layer 125 can be formed on the bottom surface substrate 121 where the address electrodes 123 are formed to cover the address electrodes 123.

Barrier ribs 122 for partitioning off discharge spaces, that is, discharge cells are formed on the lower dielectric layer 125.

Red (R), green (G), and blue (B) phosphor layers 124 that emit visible rays for displaying an image during address discharge can be formed in the discharge cells partitioned off by the barrier ribs 122.

In the above-described PDP according to an embodiment of the present invention, when driving signals are supplied to the scan electrode 112, the sustain electrode 113, and the address electrodes 123, discharge is generated by the discharge cells partitioned off by the barrier ribs 122 to realize an image.

In FIG. 3, only the PDP according to an embodiment of the present invention is illustrated and described. An embodiment of the present invention is not limited to the PDP having the structure of FIG. 3.

The operation of the plasma display apparatus according to an embodiment of the present invention comprising the PDP and the driving integrated circuit comprised in each of the scan driver 200 and the sustain driver 300 will be described as follows with reference to the attached drawing.

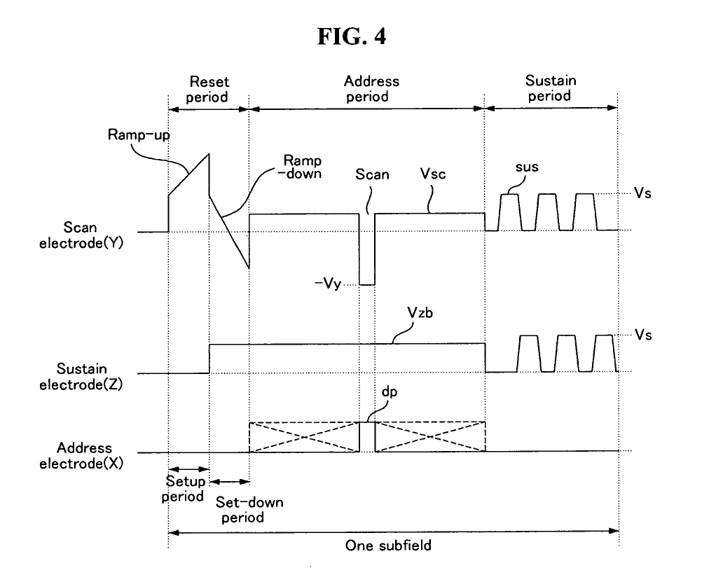

FIG. 4 illustrates the operation of the plasma display apparatus according to an embodiment of the present invention.

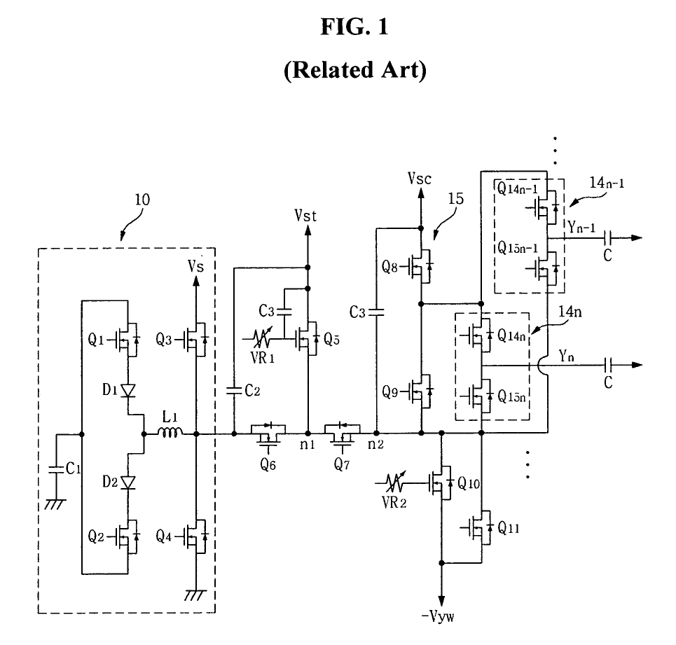

Referring to FIG. 4, the operation of the plasma display apparatus according to an embodiment of the present invention in one subfield among the plurality of subfields comprised in one frame. The scan driver 200, the sustain driver 300, and the data driver 400 that are described in FIG. 1 supply driving pulses to scan electrodes Y, sustain electrodes Z, and address electrodes X in at least one periods among a reset period, an address period, and a sustain period.

The scan driver 200 can supply rising ramp pulses Ramp-up to the scan electrodes Y in the set up period of the reset period.

Weak discharge is generated in the discharge cells of an entire screen by the rising ramp pulses. Positive polar wall charges are accumulated on the address electrodes X and the sustain electrodes Z and negative polar wall charges are accumulated on the scan electrodes Y by the set up discharge.

In addition, the scan driver 200 can supply the rising ramp pulses to the scan electrodes Y in a set down period and then, can supply the falling ramp pulses Ramp-down that start to fall from a positive voltage lower than the highest voltage of the rising ramp pulses to fall to a specific voltage level no more than a ground level voltage GND that is a reference voltage.

Therefore, weak erase discharge is generated in the discharge cells to sufficiently erase wall charges that are excessively formed in the discharge cells. Wall charges that can stably generate the address discharge uniformly reside in the discharge cells by the set down discharge.

The sustain driver 300 supplies a sustain bias voltage Vzb to the sustain electrodes Z in the set down period and during the address period. The sustain bias voltage Vab reduces a voltage difference between the scan electrodes Y and the sustain electrodes Z to prevent erroneous discharge from being generated.

In addition, the scan driver 200 can supply negative polar scan pulses that fall from a scan bias voltage to the scan electrodes during the address period.

The lowest voltage of the negative polar scan pulses is lower than the lowest voltage of the falling ramp pulses to reduce the highest voltage of positive polar data pulses.

The data driver 400 supplies the positive polar data pulses to the address electrodes X to correspond to the negative polar scan pulses.

A voltage difference between the scan pulses and the data pulses and the wall voltage generated in the reset period are added to each other to generate the address discharge in the discharge cells to which the data pulses are supplied. Wall charges that can generate discharge when the sustain voltage Vs is supplied are formed in the discharge cells selected by the address discharge.

The scan driver 200 and the sustain driver 300 supply sustain pulses SUS to the scan electrodes Y and the sustain electrodes Z during the sustain period after the address period. Therefore, in the discharge cells selected by the address discharge, the wall voltage in the discharge cells and the sustain pulse SUS are added to each other so that the sustain discharge is generated between the scan electrodes Y and the sustain electrodes Z whenever the sustain pulses SUS are supplied.

The above-described driving operation is in accordance with an embodiment. An erase period in which wall charges that reside after the sustain discharge are erased can be further added after the sustain period and a free reset period in which wall charges can be stably formed in the electrodes can be further added before the reset period.

In addition, in FIG. 4, the scan driver 200 and the sustain driver 300 independently operate. However, the scan driver 200 and the sustain driver 300 can unitedly operate.

The driving integrated circuit comprised in each of the scan driver and the sustain driver that supply the sustain pulses to the sustain electrodes during the sustain period as described above will be described in detail as follows.

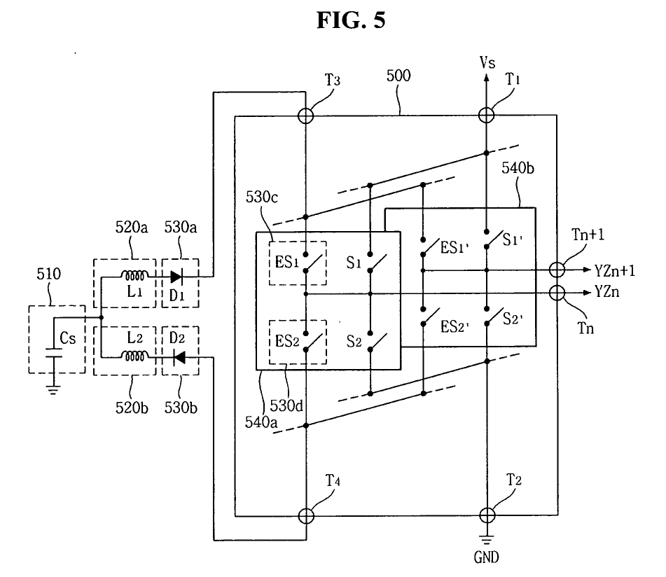

FIG. 5 illustrates a plasma display apparatus comprising a driving integrated circuit according to an embodiment of the present invention.

Referring to FIG. 5, each of the scan driver 200 and the sustain driver 300 comprises an energy storage unit 51, resonance forming units 520a and 520b, energy controllers 530a and 530b, and a driving integrated circuit 500.

The energy storage unit 510 comprises a capacitor Cs and a half Vs/2 of the sustain voltage that is the highest voltage of the sustain pulses is stored in the capacitor Cs.

The resonance forming units 520a and 520b form resonance together with the PDP. The resonance forming units 520a and 520b comprise the first resonance forming unit 520a and the second resonance forming unit 520b. The first resonance forming unit 520a comprises a first inductor L1 and the second resonance forming unit 520b comprises a second inductor L2. The first inductor L1 forms resonance together with the PDP so that energy is supplied from the energy storage unit 510 to the scan electrodes and the sustain electrodes YZn. The second inductor L2 forms resonance together with the PDP so that energy is recovered from the scan electrodes and the sustain electrodes YZn to the energy storage unit 510.

One end of the first resonance forming unit 520a is electrically and commonly connected to the energy storage unit 510 and the other end of the second resonance forming unit 520b. The other end of the first resonance forming unit 520a is electrically connected to the anode end of a first diode D1. One end of the second resonance forming unit 520b is electrically connected to the cathode end of a second diode D2.

At this time, the inductance of the first inductor L1 is different from the inductance of the second inductor L2.

That is, the inductance of the first inductor L1 can be smaller than the inductance of the second inductor L2. This is because a voltage can be increases within a shorter time as the inductance is smaller. Therefore, smaller inductance can be connected to the supply path of energy to be rapidly increased to the sustain voltage Vs that is the highest voltage of the sustain pulses.

The driving integrated circuit 500 supplies energy from the energy storage unit 510 to the scan electrodes and the sustain electrodes YZn through resonance, recovers energy from the scan electrodes and the sustain electrodes YZn to the energy storage unit 510, or supplies the sustain voltage Vs supplied to a sustain constant voltage source or the reference voltage GND supplied from a reference constant voltage source to the scan electrodes and the sustain electrodes YZn.

The driving integrated circuit 500 comprises a driving module 540a. The driving module 540a comprises a first voltage supply switch S1 that forms a path that supplies the scan bias voltage to the scan electrodes during the address period or that supplies the positive sustain voltage Vs that is the highest voltage of the sustain pulses to the scan electrodes and the sustain electrodes YZn during the sustain period and a second voltage supply switch S2 that forms a path that supplies the write scan voltage that is the lowest voltage of the scan pulses to the scan electrodes during the address period or that supplies a reference voltage to the scan electrodes and the sustain electrodes YZn during the sustain period. At this time, the energy supply switch ES1 and the energy recovery switch ES2 of the energy controllers are arranged in the driving module.

The energy controllers 530a, 530b, 530c, and 530d comprise the energy supply switch 530c that forms a path that supplies energy for forming the sustain pulses to the scan electrodes and the sustain electrodes YZn, the energy recovery switch 530d that forms a path that recovers energy for forming the sustain pulses from the scan electrodes and the sustain electrodes YZn, a first reverse current intercepting unit 530a for intercepting reverse current between the scan electrodes and the sustain electrodes YZn and the resonance forming units 520a and 520b, and a second reverse current intercepting unit 530b for intercepting reverse current between the scan electrodes and the sustain electrodes YZn and the resonance forming units 520a and 520b.

Here, the first reverse current intercepting unit 530a comprises the first diode D1 and the second reverse current intercepting unit 530b comprises the second diode D2. The first diode D1 intercepts reverse current between the first inductor L1 and the energy supply switch ES1 and the second diode D2 intercepts reverse current between the second inductor L2 and the energy recovery switch ES2.

At this time, one end of the energy supply switch ES1 is connected to the cathode end of the first diode D1, the other end of the energy supply switch ES1 is commonly connected to one end of the energy recovery switch ES2, the other end of the first voltage supply switch S1, and one end of the second voltage supply switch S2, and the other end of the energy recovery switch ES2 is connected to the anode end of the second diode D2.

As described above, the supply path of energy is made different from the recovery path of energy to reduce the heat generated by the inductors, to reduce influence caused by a mutual operation between the energy supply switch 530c and the energy recovery switch 530d, and to improve driving efficiency.

In the energy storage unit 550Cs, the first resonance forming unit 540a and the second resonance forming unit 540b are connected to each other to store the energy supplied or recovered during the sustain period.

At least two elements among the energy supply switch 530c, the energy recovery switch 530d, the first reverse current intercepting unit 530a, and the second reverse current intercepting unit 530b that are the elements that constitute the energy controllers 530a, 530b, 530c, and 530d are arranged in the driving module 540a.

The driving integrated circuit 500 comprises a first terminal T1 to a fifth terminal Tn and Tn+1. The first terminal T1 supplies the scan bias voltage or the sustain voltage Vs that is the highest voltage of the sustain pulses to the scan electrodes during the address period and is electrically connected to one end of the first voltage supply switch S1. The second terminal T2 supplies the write scan voltage that is the lowest voltage of the scan pulses or the reference voltage GND and is electrically connected to the other end of the second voltage supply switch S2. The third terminal T3 is comprised in the path that supplies the energy for forming the sustain pulses to the scan electrodes and the sustain electrodes YZn and is connected to the anode end of the first diode. The fourth terminal T4 is comprised in the path that recovers the energy for forming the sustain pulses from the scan electrodes and the sustain electrodes YZn and is connected to the cathode terminal of the second diode D2. The fifth terminal Tn and Tn+1 is electrically connected to the scan electrodes and the sustain electrodes YZn.

Here, the fifth terminal Tn and Tn+1 can be singular or plural. In addition, the number of fifth terminals Tn and Tn+1 can be actually equal to the number of scan electrodes and sustain electrodes YZn.

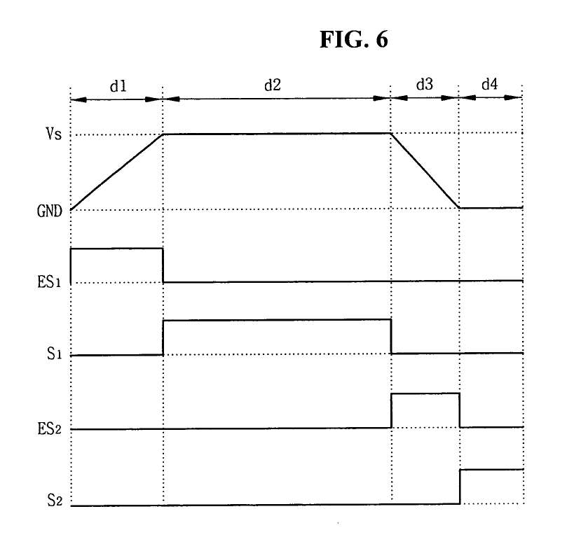

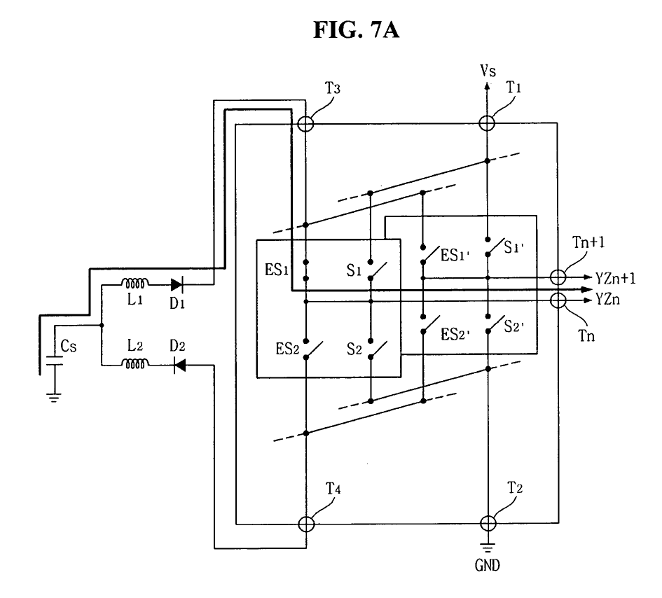

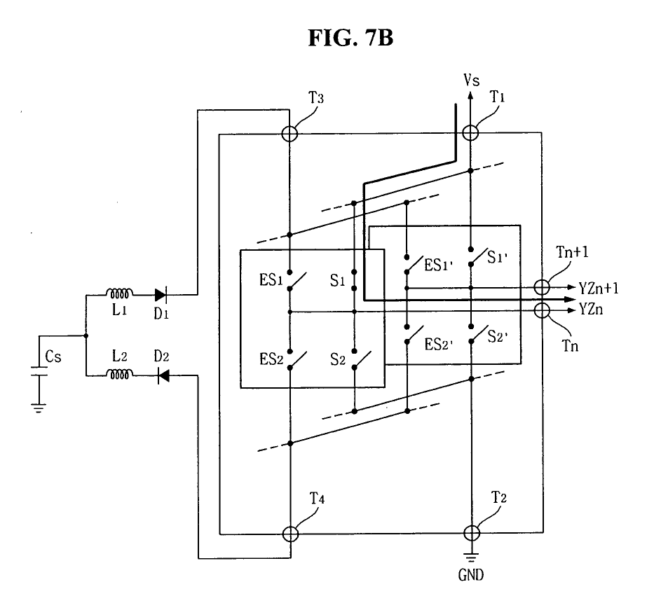

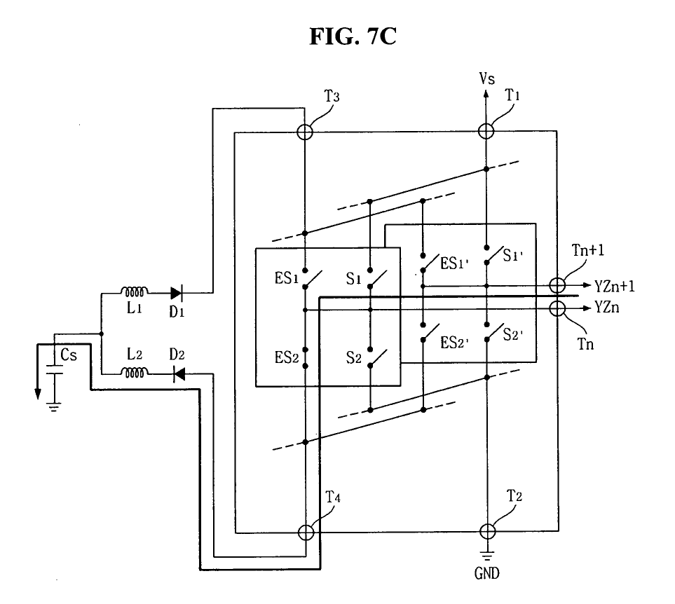

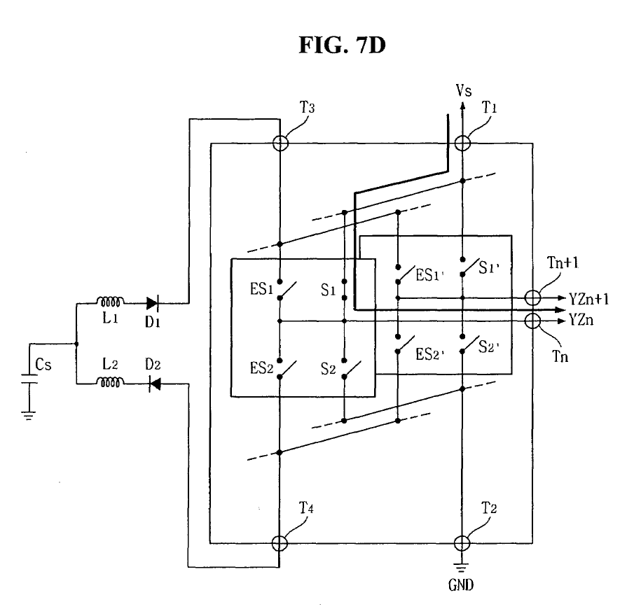

FIG. 6 illustrates the switching timing of the plasma display apparatus comprising the driving integrated circuit according to an embodiment of the present invention. FIGS. 7A to 7D illustrates a method of driving the driving integrated circuit in accordance with the switching timing of FIG. 6.

First, it is assumed that the half of the sustain voltage Vs is stored in the capacitor Cs that is the energy storage unit 510 and that the scan electrodes and the sustain electrodes YZn are at a ground level voltage GND.

Referring to FIG. 6, when the energy supply switch ES1 is turned on in a period d1, the current path illustrated in FIG. 7A is formed.

In accordance with the current path, energy that passes through the first inductor L1 is supplied to the third terminal T3 of the driving integrated circuit 500. The energy supplied to the third terminal T3 as described above forms resonance between the first inductor L1 and the PDP and is supplied to the fifth terminal Tn through the energy supply switch ES1. The energy supplied to the fifth terminal Tn as described above gradually increases the voltage of the scan electrodes and the sustain electrodes YZn from the reference voltage GND to the sustain voltage Vs.

Then, when the first voltage supply switch S1 is turned on in a period d2, the current path illustrated in FIG. 7B is formed.

In accordance with the current path, the sustain voltage that is the highest voltage of the sustain pulses that is supplied from the sustain constant voltage source to the first terminal T1 of the driving integrated circuit 500 is supplied to the fifth terminal Tn via the first voltage supply switch S1. Therefore, the sustain voltage Vs is supplied to the scan electrodes and the sustain electrodes YZn electrically connected to the fifth terminal Tn and the sustain voltage Vs is supplied for a predetermined time.

Then, when the energy recovery switch ES2 is turned on in a period d3, the current path illustrated in FIG. 7C is formed.

In accordance with the current path, energy is recovered from the scan electrodes and the sustain electrodes YZn electrically connected to the fifth terminal Tn of the driving integrated circuit 500 and the recovered energy is recovered to the capacitor Cs via the second inductor L2 electrically connected to the energy recovery switch ES2 and the fourth terminal T4. In the above-described processes, resonance is generated between the second inductor L2 and the PDP so that the half of the sustain voltage Vs is stored in the capacitor Cs and the sustain voltage Vs of the scan electrodes and the sustain electrodes YZn gradually falls from the sustain voltage Vs to the reference voltage GND.

Then, when the second voltage supply switch S2 is turned on in a period d4, the current path illustrated in FIG. 7D is formed.

In accordance with the current path, the reference voltage GND supplied from the reference voltage source to the fourth terminal T4 of the driving integrated circuit 500 is supplied to the fifth terminal Tn via the second voltage supply switch S2. Therefore, the reference voltage GND is supplied to the scan electrodes and the sustain electrodes YZn electrically connected to the fifth terminal Tn and the reference voltage GND is supplied for a predetermined time.

As described above, the energy, the sustain voltage Vs, and the reference voltage GND supplied to the first terminal T1, the second terminal T2, and the third terminal T3 or the energy recovered to the fourth terminal T4 is supplied from the fifth terminal Tn to the scan electrodes and the sustain electrodes YZn or is received from the scan electrodes and the sustain electrodes YZn to the fifth terminal Tn.

In FIGS. 6 and 7A to 7D, the energy, the sustain voltage Vs, and the reference voltage GND supplied to the first terminal T1, the second terminal T2, the third terminal T3, and the fourth terminal T4 are supplied to the fifth terminal Tn so that the driving integrated circuit 500 forms one sustain pulse.

In addition, the driving integrated circuit 500 receives the energy and the sustain voltage from the first and third terminals T1 and T3 to supply the received energy and sustain voltage to the fifth terminal Tn and receives the reference voltage from the second terminal T2 to supply the received reference voltage to the fifth terminal Tn so that the sustain pulses supplied to the scan electrodes and the sustain electrodes YZn gradually rise to the sustain voltage and fall to have a steeper slope than the slope when the sustain pulses rise after the sustain voltage is supplied for a predetermined period. The driving integrated circuit 500 recovers energy to the second and fourth terminals T2 and T4 or receives the reference voltage to supply the received reference voltage to the fifth terminal Tn and then, receives the sustain voltage from the first terminal T1 to supply the sustain voltage to the fifth terminal Tn so that the sustain pulses supplied to the scan electrodes and the sustain electrodes YZn rapidly rise to the sustain voltage and gradually fall after the sustain voltage is supplied for a predetermined time.

In addition, the driving integrated circuit 500 supplies a lower voltage than the sustain voltage to the first terminal T1 so that the scan bias voltage Vsc can be supplied to the scan electrodes during the address period.

In addition, in FIGS. 6 and 7A to 7D, one driving module 540a operates in the driving integrated circuit 500. However, a plurality of driving modules 540a and 540b can be formed in the driving integrated circuit 500 and the driving modules 540a and 540b can operate in the same way as the driving module 540a to supply the sustain pulses to the scan electrodes and the sustain electrodes YZn+1.

As described above, the driving integrated circuit comprised in each of the scan driver and the sustain driver supplies the sustain pulses to the scan electrodes and the sustain electrodes during the sustain period. However, the driving integrated circuit comprised in the scan driver can supply the scan pulses to the scan electrodes during the address period, which will be described as follows.

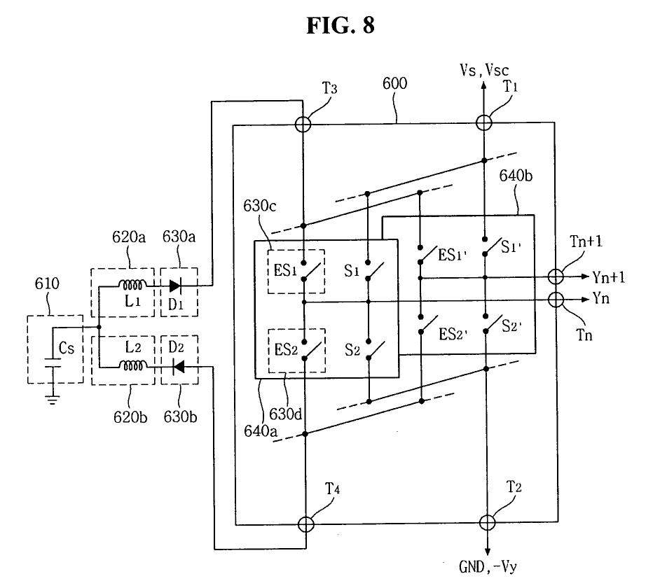

FIG. 8 illustrates a plasma display apparatus comprising a driving integrated circuit according to another embodiment of the present invention.

Referring to FIG. 8, the scan driver 200 comprises and 620b, energy controllers 630a and 630b, and a driving integrated circuit 600 and can comprise a scan bias voltage Vsc supplier (not shown) and a write scan voltage Scan supplier (not shown).

As described above, the driving integrated circuit 500 illustrated in FIG. 5 and the driving integrated circuit 600 illustrated in FIG. 8 actually have the same structure.

The scan bias voltage Vsc is supplied to the first terminal T1 during the address period, the write scan voltage Scan is further supplied to the second terminal T2, and the scan pulses are supplied to the scan electrodes Yn and Yn+1 electrically connected to the fifth terminals Tn and Tn+1.

That is, the first voltage supply switch S1 comprised in a first driving module 640a is turned on and the second voltage supply switch S2 is turned off so that, while the scan bias voltage Vsc is supplied to the scan electrode Yn through the fifth terminal Tn in the fifth terminals Tn and Tn+1, a first voltage supply switch S1′ comprised in a second driving module 640b is turned off and that a second voltage supply switch S2′ is turned on to supply the write scan voltage Scan to the scan electrode Yn+1 through the fifth terminal Tn+1 of the fifth terminals Tn and Tn+1. Therefore, the plurality of scan electrodes are sequentially scanned.

During the sustain period, the driving integrated circuit operates in the same principle as illustrated in FIGS. 6 and 7A to 7D to supply the sustain pulses to the scan electrodes Yn and Yn+1.

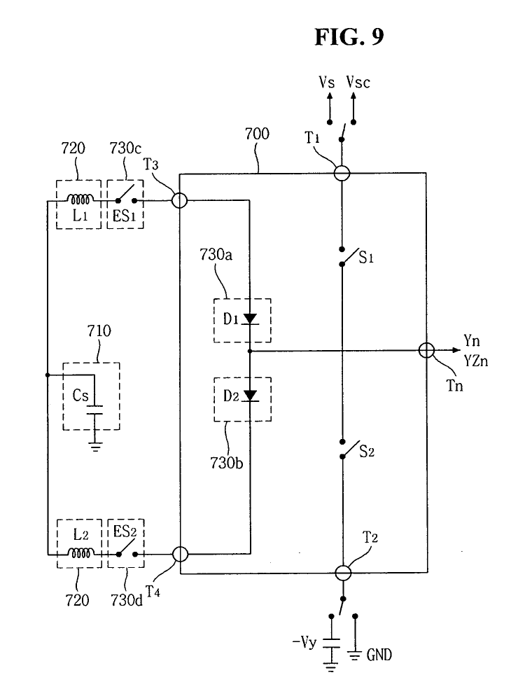

FIG. 9 illustrates a plasma display apparatus comprising a driving integrated circuit according to still another embodiment of the present invention. In FIG. 9, description of the same parts as the parts illustrated in FIG. 5 will be omitted.

Referring to FIG. 9, the plasma display apparatus according to still another embodiment of the present invention comprises a driving integrated circuit 700, energy controllers 730a, 730b, 730c, and 730d, first and second resonance forming units 720a and 720b, and an energy storage unit 710.

The driving integrated circuit 700 comprises a driving module. The driving module comprised in the driving integrated circuit 700 comprises a first voltage supply switch S1 that forms a path that supplies the scan bias voltage Vsc to the scan electrodes Y during the address period or that supplies the positive sustain voltage Vs that is the highest voltage of the sustain pulses to the scan electrodes Y during the sustain period and a second voltage supply switch S2 that forms a path that supplies the write scan voltage −Vy that is the lowest voltage of the scan pulses to the scan electrodes Y during the address period or that supplies a reference voltage GND to the scan electrodes during the sustain period.

At this time, the first reverse current intercepting unit 730a and the second reverse current intercepting unit 730b of the energy controllers 730a, 730b, 730c, and 730d can be arranged in the driving module.

At this time, the first reverse current intercepting unit 730a intercepts reverse current when the energy for forming the sustain pulses is supplied to the scan electrodes Y during the sustain period and the second reverse current intercepting unit 730b intercepts reverse current when the energy for forming the sustain pulses is recovered from the scan electrodes Y during the sustain period.

The connection relationship and the operation path of the above-described driving integrated circuit 700, the energy controllers 730a, 730b, 730c, and 730d, the first and second resonance forming units 720a and 720b, and the energy storage unit 710 will be described as follows.

One end of the first voltage supply switch S1 of the driving module comprised in the driving integrated circuit 700 is electrically connected to the first terminal T1 and the other end of the first voltage supply switch S1 is commonly connected to the cathode end of the first diode D1, the anode end of the second diode D2, one end of the second voltage supply switch S2, and the fifth terminal Tn. The other end of the second voltage supply switch S2 is electrically connected to the second terminal T2. The anode end of the first diode D1 is electrically connected to the third terminal T3. The cathode end of the second diode D2 is electrically connected to the fourth terminal T4.

The driving integrated circuit 700 of the plasma display apparatus according to still another embodiment of the present invention forms a path for forming the scan pulses.

First, during the address period, the scan bias voltage Vsc is supplied to one end of the first voltage supply switch S1 through the first terminal T1 of the driving integrated circuit 700. Therefore, the first voltage supply switch S1 is turned on and a path on which the scan bias voltage Vsc is supplied to the scan electrodes Y through the fifth terminal Tn connected to the other end of the first voltage supply switch S1 is formed.

Then, the write scan voltage −Vy of the scan pulses is supplied to the other end of the second voltage supply switch S2 through the second terminal T2 of the driving integrated circuit 700 during the address period. Therefore, the second voltage supply switch S2 is turned on and a path on which the write scan voltage −Vy of the scan pulses is supplied to the scan electrodes Y through the fifth terminal Tn connected to one end of the second voltage supply switch S2 is formed.

As described above, the driving module supplies the scan bias voltage Vsc and the write scan voltage −Vy of the scan pulses by an operation characteristic of sequentially scanning the scan electrodes Y during the address period. When the first voltage supply switch S1 is turned on, the second voltage supply switch S2 connected to the first voltage supply switch S1 is turned off. When the second voltage supply switch S2 is turned on, the first voltage supply switch S1 connected to the second voltage supply switch S2 is turned off.

The driving integrated circuit 700 of the plasma display apparatus according to still another embodiment of the present invention forms the supply path and the recovery circuit of energy in order to form the sustain pulses.

First, the energy supplied in order to form the sustain pulses during the sustain period is supplied to a first reverse current intercepting unit D1 through the third terminal T3. Therefore, the energy supply switch 730c connected to the third terminal T3 is turned on so that a path on which the voltage that increases to the sustain voltage Vs that is the highest voltage of the sustain pulses is supplied from the energy storage unit 710 Cs to the scan electrodes Y connected to the fifth terminal Tn through the first resonance forming unit 720a, the energy supply switch 730c, the third terminal T3, and the first reverse current intercepting unit D1 is formed.

Then, the positive sustain voltage Vs that is the highest voltage of the sustain pulses is supplied one end of the first voltage supply switch S1 through the first terminal T1 of the driving integrated circuit 500. Therefore, the energy supply switch 730c is turned off and the first voltage supply switch S1 is turned on so that a path on which a voltage that can sustain the positive sustain voltage Vs for a predetermined time is supplied to the scan electrodes Y through the fifth terminal Tn connected to the other end of the first voltage supply switch S1 is formed.

Then, the energy recovered in order to form the sustain pulses is supplied to the energy recovery switch 730d through the fourth terminal T4. Therefore, the first voltage supply switch S1 is turned off and the energy recovery switch 730d connected to the fourth terminal T4 is turned on so that a path on which a voltage that falls from the sustain voltage Vs that is the highest voltage of the sustain pulses to the reference voltage GND is recovered from the scan electrodes Y to the energy storage unit 710 Cs through the fifth terminal Tn, a second reverse current intercepting unit D2, the fourth terminal T4, the energy recovery switch 730d, and the second resonance forming unit 720d is formed.

Then, the reference voltage GND that is the lowest voltage of the sustain pulses is supplied to the other end of the second voltage supply switch S2 through the second terminal T2 of the driving integrated circuit 700. Therefore, the energy recovery switch 730d is turned off and the second voltage supply switch S2 is turned on so that a path on which the voltage that can sustain the reference voltage GND for a predetermined time is supplied to the scan electrodes through the fifth terminal Tn connected to one end of the second voltage supply switch 2S is formed.

In the above-described driving integrated circuits 500, 600, and 700 according to various embodiments of the present invention, since the inductors L and the capacitor Cs that constitute the energy recovery circuits can be arranged outside the driving integrated circuits, only the switching elements S and the diodes D are built in the driving integrated circuits to function as a sustainer in accordance with the connection relationship of the external elements as well as a drive integrated circuit. Therefore, a circuit structure that is easily integrated as a single integrated circuit and that can have various functions can be provided.

In addition, the driving integrated circuit is positioned in the position where the conventional drive integrated circuit of FIG. 1 is positioned so that a path from the energy recovery circuit of the sustainer to the PDP can be formed to be shorter. As the path that forms current is shorter, less noise is generated when the PDP is driven. Therefore, the plasma display apparatus according to an embodiment of the present invention can reduce driving noise to increase the driving efficiency of the PDP.

Although not shown in FIG. 9, the energy supply switch 730c, the energy recovery switch 730d, the first voltage supply switch S1, and the second voltage supply switch S2 can constitute a field effect transistor. At this time, the direction of the body diode formed in the energy supply switch 730c can be opposite to the direction of the first reverse current intercepting unit D1 and the direction of the body diode formed in the energy recovery switch 730d can be opposite to the direction of the second reverse current intercepting unit D2 in order to effectively operate the energy supply path and the energy recovery path that are separated from each other.

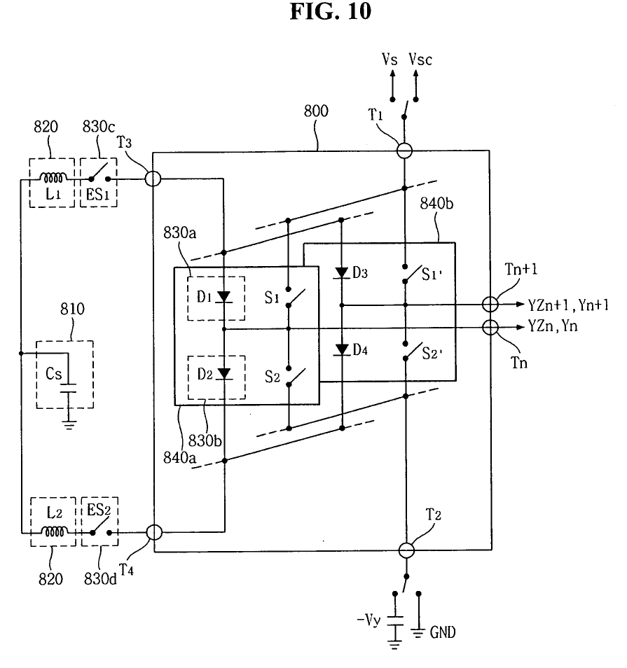

FIG. 10 illustrates a plasma display apparatus comprising a driving integrated circuit according to still another embodiment of the present invention.

Referring to FIG. 10, the plasma display apparatus according to still another embodiment of the present invention comprises a driving integrated circuit 800, energy controllers 830a, 830b, 830c, and 830d, first and second resonance forming units 820a and 820b, and an energy storage unit 810.

Since FIG. 10 is different from FIG. 9 in that a plurality of driving modules are comprised in the driving integrated circuit and the other components of FIG. 10 are actually the same as the components of FIG. 9, description of the components will be omitted and the connection relationship and the operation path of the driving integrated circuit 800, the energy controllers 830a, 830b, 830c, and 830d, the first and second resonance forming units 820a and 820b, and the energy storage unit 810 will be described as follows.

The first voltage supply switch of a first driving module 840a comprised in the driving integrated circuit 800 is electrically connected to the first terminal T1 to supply the scan bias voltage Vsc to one of the fifth terminals Tn and Tn+1 during the address period and to supply the sustain voltage Vs that is the highest voltage of the sustain pulses to one of the fifth terminals Tn and Tn+1 during the sustain period. The second voltage supply switch S2 is electrically connected to the second terminal T2 to supply the write scan voltage −Vy of the scan pulses to one of the fifth terminals Tn and Tn+1 during the address period and to supply the reference voltage GND to one of the fifth terminals Tn and Tn+1 during the sustain period. The first reverse current intercepting unit 830a is electrically connected to the third terminal T3 to supply energy supplied from the energy storage unit 810 to one of the fifth terminals Tn and Tn+1 during the sustain period. The second reverse current intercepting unit 830b is electrically connected to the fourth terminal T4 to supply energy recovered from the first scan electrode and the first sustain electrode YZn or the second scan electrode and the second sustain electrode YZn+1 to the energy storage unit 810 during the sustain period.

Since the second driving module 840b actually has the same structure as the first driving module 840a and the functions of a third voltage supply switch S1′ and a fourth voltage supply switch S2′ and the functions of the third reverse current intercepting unit D3 and the fourth reverse current intercepting unit D4 are actually the same as those of the first driving module 840a, detailed description of the second driving module 840b will be omitted.

Here, the first voltage supply switch S1 of the first driving module 840a is electrically connected to the third voltage supply switch S3 of the second driving module 840b and the second voltage supply switch S2 of the first driving module 840a is electrically connected to the fourth voltage supply switch S4 of the second driving module 840b. In addition, the first reverse current intercepting unit 830a of the first driving module 840a is electrically connected to the third reverse current intercepting unit D3 of the second driving module 840b and the second reverse current intercepting unit 830b of the first driving module 840a is electrically connected to the fourth reverse current intercepting unit D4 of the second driving module 840b.

The driving integrated circuit 800 of the plasma display apparatus according to still another embodiment of the present invention forms the supply path and the recovery path of energy in order to form the sustain pulses. Therefore, the driving integrated circuit 800 comprises the first driving module 840a and the second driving module 840b. In addition, the first reverse current intercepting unit 830b to the fourth reverse current intercepting unit D4 comprise the first diode D1 to the fourth diode D4, respectively.

The anode end of the first diode D1 of the first driving module 840a is connected to the third terminal T3 and the cathode end of the first diode D1 is connected to the fifth terminal Tn. Therefore, an energy supply switch 630c is turned on so that a path on which the voltage that increases to the sustain voltage Vs that is the highest voltage of the sustain pulses through the first diode D1 is supplied from the energy storage unit 810 to the first scan electrode and the sustain electrode YZn connected to the fifth terminal Tn through the first resonance forming unit 820a, the energy supply switch 830c, the third terminal T3, and the first diode D1 is formed.

One end of the first voltage supply switch S1 is connected to the first terminal T1 and the other end of the first voltage supply switch S1 is connected to the fifth terminal Tn. Therefore, the energy supply switch 830c is turned off and then, the first voltage supply switch S1 is turned on so that a path on which a voltage that supplies the sustain voltage Vs for a predetermined time is supplied to the first scan electrode and the second sustain electrode YZn that are connected to the fifth terminal Tn is formed.

The cathode end of the second diode D2 is connected to the fourth terminal T4 and the anode end of the second diode D2 is connected to the fifth terminal Tn. Therefore, the first voltage supply switch S1 is turned off and then, the energy recovery switch 830d is turned on so that a path on which a voltage that falls from the sustain voltage Vs to the reference voltage GND through the second diode D2 is recovered from the first scan electrode and the sustain electrode YZn to the energy storage unit 810 through the second diode D2, the fourth terminal T4, the energy recovery switch 830d, and the second resonance forming unit 820b is formed.

The other end of the second switch S2 is connected to the second terminal T2 and one end of the second switch S2 is connected to the fifth terminal Tn. Therefore, the energy recovery switch 830d is turned off and then, the second switch S2 is turned on so that a path on which a voltage that supplies the reference voltage GND for a predetermined time is supplied to the first scan electrode and the sustain electrode YZn that are connected to the fifth terminal Tn is formed.

The components of the first driving module 840a were described. However, the operations of the components of the second driving module 840b are actually the same as the operations of the components of the first driving module 840a.

In addition, a driving integrated circuit 600 of the plasma display apparatus according to still another embodiment of the present invention forms a path for forming the scan pulses.

First, one end of the first voltage supply switch S1 of the first driving module 840a is connected to the first terminal 611 and the other end of the first voltage supply switch S1 is connected to the fifth terminal Tn of the fifth terminals Tn and Tn+1. Therefore, the first voltage supply switch S1 is turned on so that a path on which the scan bias voltage Vsc is supplied to the first scan electrode Yn through the fifth terminal 615 is formed.

The other end of the fourth voltage supply switch S4 of the second driving module 840b is connected to the second terminal T2 and one end of the fourth voltage supply switch S4 is connected to the fifth terminal Tn+1 of the fifth terminals Tn and Tn+1. Therefore, the fourth voltage supply switch S4 is turned on so that a path on which the write scan voltage −Vy of the scan pulses is supplied to the second scan electrode Yn+1 through the fifth terminal Tn+1 of the fifth terminals Tn and Tn+1 is formed.

The first driving module 840a and the second driving module 840b supply the scan bias voltage Vsc and the write scan voltage −Vy of the scan pulses, respectively, by the operation characteristic of sequentially scanning the scan electrodes during the address period.

Therefore, when the first voltage supply switch S1 of the first driving module 840a is turned on, the third voltage supply switch S3 of the second driving module 840b connected to the first voltage supply switch S1 of the first driving module 840a is turned off. When the fourth voltage supply switch S4 of the second driving module 840b is turned on, the second voltage supply switch S2 of the first driving module 840a connected to the fourth voltage supply switch S4 of the second driving module 840b is turned off.

In addition, in FIG. 10, the first scan electrode and the first sustain electrode YZn and the second scan electrode and the second sustain electrode YZn+1 are adjacent to each other, however, may not be adjacent to each other.

Since the effect of FIG. 10 is actually the same as the effect of FIG. 9, description thereof will be omitted.

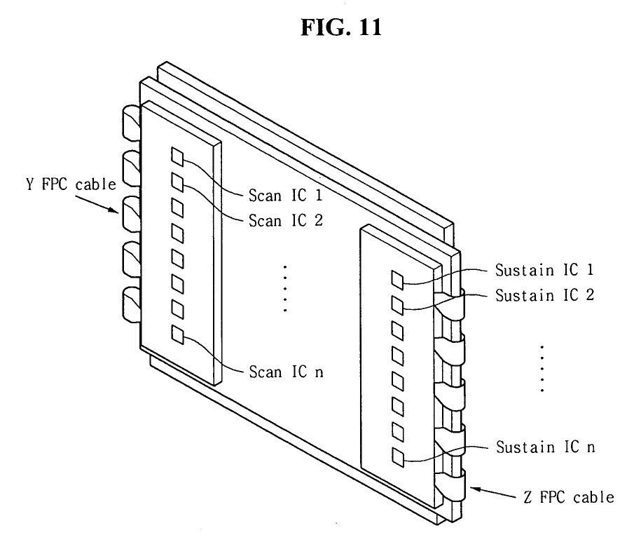

FIG. 11 illustrates that driving integrated circuits comprised in a scan driver and a sustain driver according to various embodiments of the present invention are provided on the bottom surface of a PDP.

Referring to FIG. 11, in the plasma display apparatus, driving integrated circuits Scan IC1 to Scan ICn comprised in the scan driver are connected to the plurality of scan electrodes by a plurality of flexible printed circuit (FPC) cables and driving integrated circuits Sustain IC1 to Sustain ICn comprised in the sustain driver are connected to the plurality of sustain electrodes by a plurality of Z FPC cables to be arranged on the bottom surface of the PDP.

As described above, the driving integrated circuits are comprised in the scan driver and the sustain driver to simplify the scan driver and the sustain driver, to integrate the switching elements of circuits into one integrated circuit, and to save manufacturing cost.

In addition, the switching elements of the circuits of the scan driver and the sustain driver are formed into one module to improve the operation stability of the scan driver and the sustain driver.

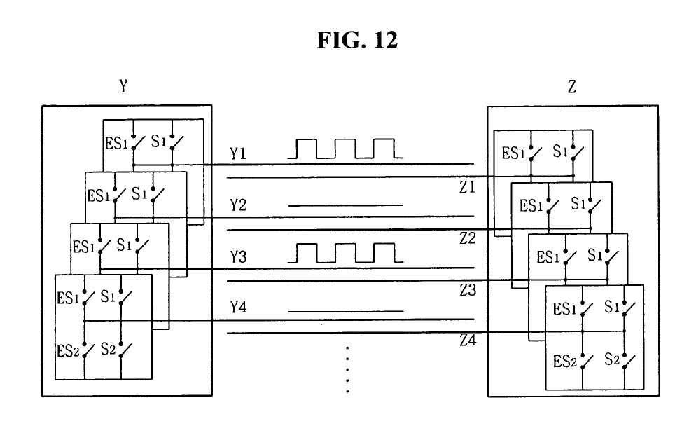

The scan electrodes and the sustain electrodes can be independently controlled through the driving integrated circuits comprised in the scan driver and the sustain driver, which will be described in FIG. 12.

FIG. 12 illustrates that scan electrodes and sustain electrodes are independently controlled by the driving integrated circuits according to various embodiment of the present invention.

Referring to FIG. 12, the scan electrodes and the sustain electrodes are formed of a plurality of electrode lines, respectively.

The plurality of driving integrated circuits supply the sustain pulses only to the odd scan electrode lines and the odd sustain electrode lines and do not supply sustain signals to the even scan electrode lines and the even sustain electrode lines.

As described above, the plurality of driving integrated circuits distinguish the lines to which the sustain pulses are supplied from the lines to which the sustain pulses are not supplied to prevent unnecessary sustain pulses from being supplied to the scan electrodes and the sustain electrodes. Therefore, power consumption can be reduced.

For example, when a movie is viewed by a wide vision, an image is not displayed in the upper and lower ends of the PDP. In such a case, the sustain pulses are not supplied to the upper and lower ends of the PDP to reduce the power consumption.

In addition, the scan electrode lines and the sustain electrode lines are independently controlled to improve the picture quality of the plasma display apparatus.

For example, a latent image can be generated in the outline of the PDP due to the manufacturing processes of the PDP. In such a case, only the sustain signals supplied to the upper and lower end scan electrode lines and the sustain electrode lines of the PDP are controlled to overlap each other to remove the latent image.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus, comprising:
a plasma display panel (PDP) comprising scan electrodes and sustain electrodes;
a driving integrated circuit comprising a driving module, the driving module supplying scan pulses to the scan electrodes during an address period and supplying sustain pulses to the scan electrodes and the sustain electrodes during a sustain period;
a first resonance forming unit that supplies energy for forming the sustain pulses to the scan electrodes and the sustain electrodes;
a second resonance forming unit that recovers energy for forming the sustain pulses from the scan electrodes and the sustain electrodes;
an energy storage unit that stores the energy during the sustain period; and
an energy controller that forms a path for supplying the energy to the scan electrodes and the sustain electrodes or a path for recovering the energy from the scan electrodes and the sustain electrodes,
wherein the first resonance forming unit comprises a first inductor,
wherein the second resonance forming unit comprises a second inductor, and
wherein inductance of the first inductor is different from inductance of the second inductor.

2. The plasma display apparatus of claim 1, wherein the energy controller comprises:
an energy supply switch that forms a path that supplies the energy for forming the sustain pulses to the scan electrodes and the sustain electrodes;
an energy recovery switch that forms a path that recovers the energy for forming the sustain pulses from the scan electrodes and the sustain electrodes;
a first reverse current intercepting unit that intercepts a reverse current between the scan electrodes and the sustain electrodes and the resonance forming units; and
a second reverse current intercepting unit for intercepting reverse current between the scan electrodes and the sustain electrodes and the resonance forming unit.

3. The plasma display apparatus of claim 2, wherein the driving module comprises:
a first voltage supply switch that forms a path that supplies a scan bias voltage to the scan electrodes during the address period or that supplies a positive sustain voltage that is the highest voltage of the sustain pulses to the scan electrodes and the sustain electrode during the sustain period; and
a second voltage supply switch that forms a path that supplies a write scan voltage that is the lowest voltage of the scan pulses to the scan electrodes during the address period or that supplies a reference voltage to the scan electrodes and the sustain electrodes during the sustain period,
wherein at least two of the energy supply switch, the energy recovery switch, the first reverse current intercepting unit, and the second reverse current intercepting unit of the energy controller are arranged in the driving module.

4. The plasma display apparatus of claim 3, wherein the first reverse current intercepting unit comprises a first diode,
wherein the second reverse current intercepting unit comprises a second diode,
wherein an anode end of the first diode is connected to the other end of the energy supply switch,
wherein a cathode end of the first diode is commonly connected to an anode end of the second diode, the other end of the first voltage supply switch, and one end of the second voltage supply switch, and
wherein a cathode end of the second diode is connected to one end of the energy recovery switch.

5. The plasma display apparatus of claim 4, wherein the driving integrated circuit comprises a first terminal to a fifth terminal,
wherein the first terminal receives the scan bias voltage or the sustain voltage that is the highest voltage of the sustain pulses and is electrically connected to one end of the first voltage supply switch,
wherein the second terminal receives the write scan voltage that is the lowest voltage of the scan pulses or the reference voltage and is electrically connected to the other end of the second voltage supply switch,
wherein the third terminal is comprised in a path for supplying the energy for forming the sustain pulses to the scan electrodes and the sustain electrodes and is connected to the anode end of the first diode,
wherein the fourth terminal is comprised in a path for recovering the energy for forming the sustain pulses from the scan electrodes and the sustain electrodes and is connected to the cathode end of the second diode, and
wherein the fifth terminal is electrically connected to the scan electrodes and the sustain electrodes.

6. The plasma display apparatus of claim 5, wherein the driving integrated circuit comprises at least one driving module and is integrated into a single integrated circuit.

7. The plasma display apparatus of claim 1, wherein the first resonance forming unit and the second resonance forming unit are arranged between the energy controller and the energy storage unit.

8. The plasma display apparatus of claim 1, wherein the inductance of the first inductor is smaller than the inductance of the second inductor.

9. The plasma display apparatus of claim 4, wherein one end of the first resonance forming unit is electrically and commonly connected to the energy storage unit and the other end of the second resonance forming unit,
wherein the other end of the first resonance forming unit is electrically connected to one end of the energy supply switch, and
wherein one end of the second resonance forming unit is electrically connected to the other end of the energy recovery switch.

10. The plasma display apparatus of claim 3, wherein the first reverse current intercepting unit comprises a first diode,
wherein the second reverse current intercepting unit comprises a second diode,
wherein one end of the energy supply switch is connected to the cathode end of the first diode,
wherein the other end of the energy supply switch is commonly connected to one end of the energy recovery switch,
the other end of the first voltage supply switch, and one end of the second voltage supply switch, and
wherein the other end of the energy recovery switch is connected to the anode end of the second diode.

11. The plasma display apparatus of claim 10, wherein the driving integrated circuit comprises a first terminal to a fifth terminal,
wherein the first terminal receives the scan bias voltage or the sustain voltage that is the highest voltage of the sustain pulses and is electrically connected to one end of the first voltage supply switch,
wherein the second terminal receives the write scan voltage that is the lowest voltage of the scan pulses or the reference voltage and is electrically connected to the other end of the second voltage supply switch,
wherein the third terminal is comprised in a path for supplying the energy for forming the sustain pulses to the scan electrodes and the sustain electrodes and is electrically connected to one end of the energy supply switch,
wherein the fourth terminal is comprised in a path for recovering the energy for forming the sustain pulses from the scan electrodes and the sustain electrodes and is electrically connected to the other end of the energy recovery switch, and
wherein the fifth terminal is electrically connected to the scan electrodes and the sustain electrodes.

12. The plasma display apparatus of claim 11, wherein the driving integrated circuit comprises at least one driving module and is integrated into a single integrated circuit.

13. The plasma display apparatus of claim 10, wherein one end of the first resonance forming unit is electrically and commonly connected to the energy storage unit and the other end of the second resonance forming unit,
wherein the other end of the first resonance forming unit is electrically connected to the anode end of the first diode, and
wherein one end of the second resonance forming unit is electrically connected to the cathode end of the second diode.

14. The plasma display apparatus of claim 3, wherein the energy supply switch and the energy recovery switch are arranged in the driving module.

15. The plasma display apparatus of claim 3, wherein the first reverse current intercepting unit and the second reverse current intercepting unit are arranged in the driving module.

16. The plasma display apparatus of claim 1, wherein the driving integrated circuit independently controls the scan electrodes and the sustain electrodes formed of a plurality of electrode lines, respectively.
